(19) United States
(12) Patent Application Publication
(10) Pub. No.: US 2004/0128904 A1
(43) Pub. Date: Jul. 8, 2004

(54) Mosquito trap

(76) Inventor: Sui-Mu Chen, Taoyuan (TW)

Correspondence Address: PRO-TECHTOR INTERNATIONAL, 20775 Norada Court, Saratoga, CA, 95070-3018, US

(21) Appl. No.: 10/338,303

(22) Filed: Jan. 7, 2003

(51) Int. Cl. A01M 1/06; A01M 1/08; A01M 5/08

(52) U.S. Cl. 43/139

(57) ABSTRACT

A mosquito trap includes a base, a carbon dioxide container for discharging carbon dioxide to a position near the base, a mosquito collection box mounted in the base, and a fan motor for introducing air into the mosquito collection box. The fan motor creates a wind pressure sufficiently strong to kill mosquitoes trapped in the mosquito collection box.

### BACKGROUND OF THE INVENTION

1. Field of the Invention

The present invention relates to a mosquito trap that discharges carbon dioxide to lure mosquitoes.

2. Description of the Related Art

Mosquito bite cause itches and disturb sleep and what is worse is several vital diseases such as malaria, Dengue fever etc. are disseminated through mosquitoes. Mosquito lamps have been developed for killing mosquitoes by means of luring mosquitoes by light. Nevertheless, the effect was found dissatisfactory, it is carbon dioxide that lures the mosquitoes, not the light. Electric mosquito traps are an alternative choice that kills mosquito by electricity, yet it needs the user to sway the electric mosquito trap to chase the mosquitoes, which is time-consuming and labor intensive.

### SUMMARY OF THE INVENTION

An object of the present invention is to provide a mosquito trap that discharges carbon dioxide to lure mosquitoes.

In accordance with a first aspect of the invention, a mosquito trap includes a base, a carbon dioxide container for discharging carbon dioxide to a position near the base, a mosquito collection box mounted in the base, and a fan motor for introducing air into the mosquito collection box. The fan motor creates a wind pressure sufficiently strong to kill mosquitoes trapped in the mosquito collection box.

In accordance with a first aspect of the invention, a mosquito trap includes a base having a central opening in a top side thereof, a mosquito collection box removably mounted in the base, a lower frame mounted in the base and located above the mosquito collection box, the lower frame defining an outlet chamber, an upper frame mounted above the base and defining an inlet chamber in alignment with the central opening of the base and the outlet chamber, a fan motor mounted in the central opening of the base, the fan motor driving ambient air into the mosquito collection box via the inlet chamber and the outlet chamber, and a carbon dioxide container for discharging carbon dioxide to a position near the base. The fan motor creates a wind pressure sufficiently strong to kill mosquitoes trapped in the mosquito collection box.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a mosquito trap in accordance with the present invention.

FIG. 2 is another perspective view of the mosquito trap in accordance with the present invention, showing the other side of the mosquito trap.

FIG. 3 is an exploded perspective view of the mosquito trap in accordance with the present invention.

FIG. 4 is a sectional view of the mosquito trap in accordance with the present invention.

FIG. 5 is another sectional view of the mosquito trap in accordance with the present invention.

FIG. 6 is a sectional view similar to FIG. 4, illustrating operation of the mosquito trap in accordance with the present invention.

### DETAILED DESCRIPTION OF THE PREFERRED EMBODIMENT

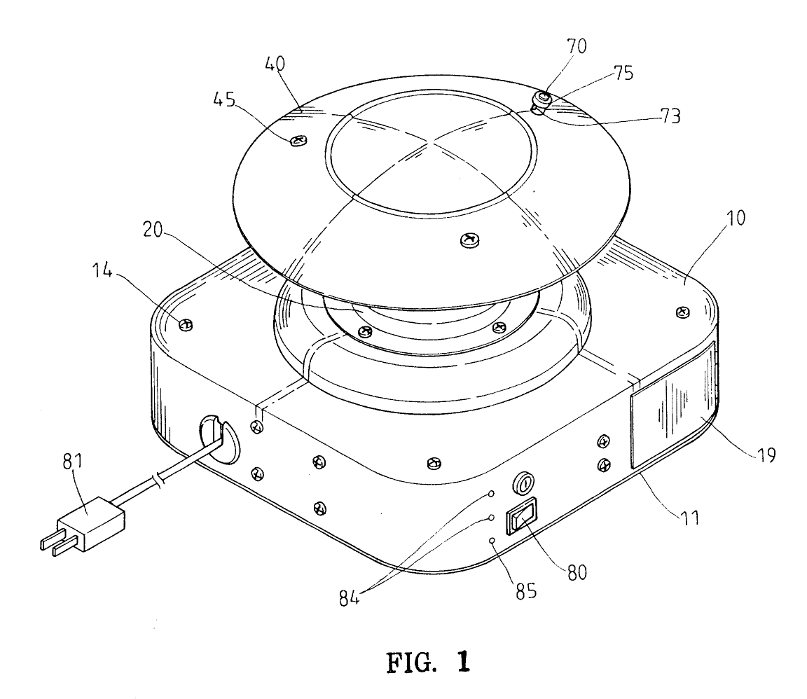

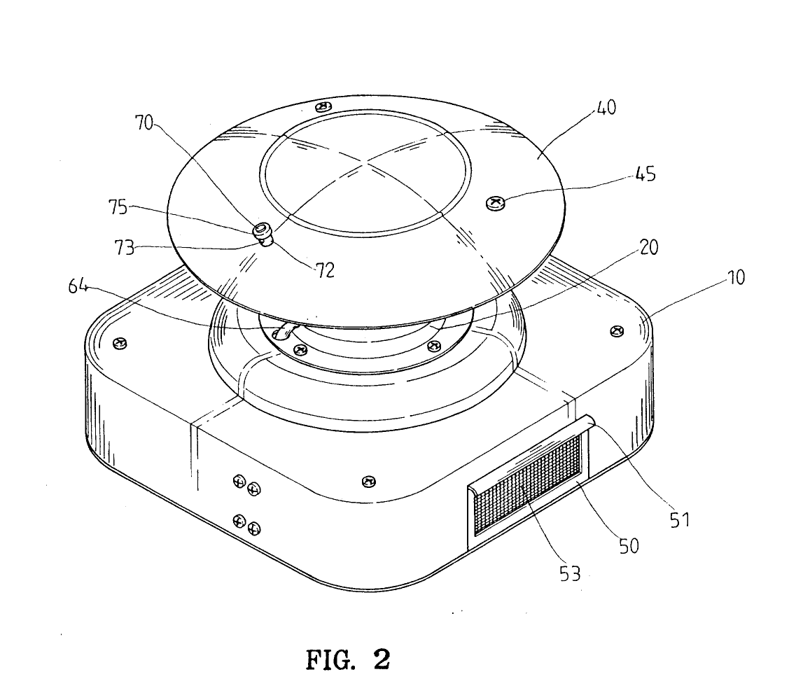

Referring to FIGS. 1 through 4, a mosquito trap in accordance with the present invention generally comprises a base 10 with a bottom cover 11 attached to a bottom thereof, thereby forming a space for receiving associated elements. The mosquito trap further includes a plug 81 for connection with an AC or DC power source. The base 10 further includes a power switch 80, indicating lamps 84, and a light switch 85 mounted thereto.

An upper frame 20 is mounted on top of the base 10, and a top cover 40 is mounted above the upper frame 20. A carbon dioxide discharging member 70 is mounted to the top cover 40. A mosquito collection box 50 is mounted in the base 10 and has a grip 51 for easy insertion into the base 10 and removal out of the base 10.

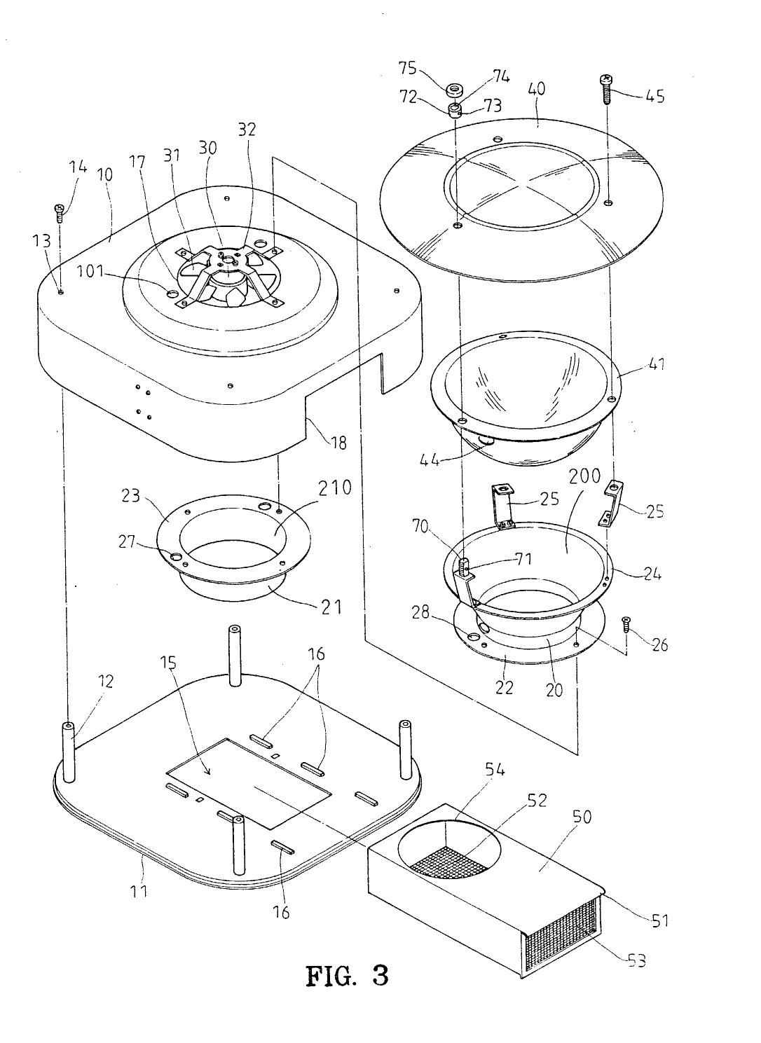

Referring to FIG. 3, the bottom cover 11 has a plurality of posts 12 located on the corners thereof, and bolts 14 are extended through holes 13 in the base 10 and screw holes (not labeled) in the posts 12 to thereby secure the bottom cover 11 to the base 10. An outlet opening 15 is provided in a central portion of the bottom cover 11, and an engaging device is provided on the bottom cover 11 for engaging with the mosquito collection box 50. In this embodiment, two rows of rails 16 are provided on two sides of the outlet opening 15, and the mosquito collection box 50 is configured to slide along the rails 16.

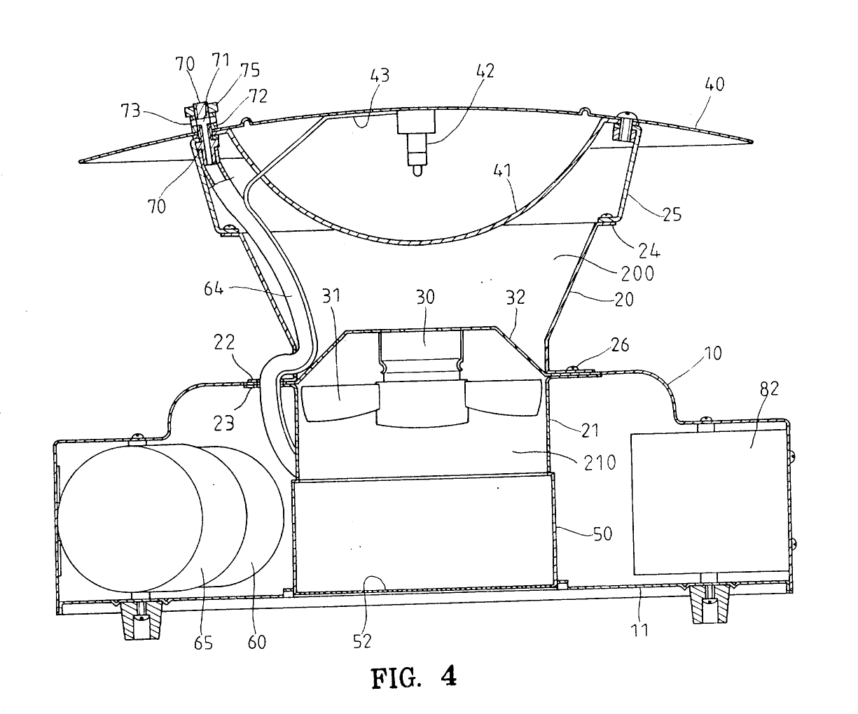

Referring to FIGS. 3 and 4, a fan device is mounted to a central opening 17 on an upper end of the base 10. The fan device includes a fan motor 30, blades 31 driven by an output shaft (not labeled) of the fan motor 30, and a fan frame 32 for fixing the fan motor 30. The upper frame 20 mounted above the base 10 defines an inlet chamber 200, and a lower frame 21 mounted between the mosquito collection box 50 and the fan frame 32 defines an output chamber 210. The fan device cooperates with the inlet chamber 200 and the outlet chamber 210 to create a wind pressure device. In this embodiment, the upper frame 20, the lower frame 21, the base 10, and the fan frame 32 are stacked one on another, and bolts 26 are extended through hole (not labeled) in a lower flange 22 of the upper frame 20, holes (not labeled) in the fan frame 32, holes (not labeled) in the base 10, and holes (not labeled) in an upper flange 23 of the lower frame 21. A plurality of brackets 25 are provided and each of which has a lower end mounted to an upper flange 24 of the upper frame 20. Bolts 45 are provided to connect a transparent lampshade 41 and the top cover 45 to the upper ends of the brackets 25. A carbon dioxide discharging member 70 is mounted to one of the brackets 25 and has an end extending beyond the top cover 40. The carbon dioxide discharging member 70 includes a carbon dioxide discharge hole 71. A sleeve 72 is mounted (by a nut 75) around the carbon dioxide discharging member 70 and has a transverse passage 73 aligned with the carbon dioxide discharge hole 71 and a longitudinal hole 74. The light switch 85 turns on the fan motor 30 at night and turns off the fan motor 30 at day and controls discharge of carbon dioxide.

The mosquito collection box 50 can be inserted into or removed from the base 10 via an access 18 in a side of the base 10. Further, the mosquito collection box 50 includes a through-hole 54 defined in an end thereof and aligned with the central hole 15 of the bottom cover 11, with a mesh 52 mounted to a bottom end of the through-hole 54. Further, another net 53 is attached to a side of the mosquito collection box 50. Thus, the air may pass the mesh 52 of the mosquito collection box 50 and exit the bottom cover 11 through the central opening 15. The meshes 52 and 53 prevent the mosquitoes from escaping out of the mosquito collection box 50.

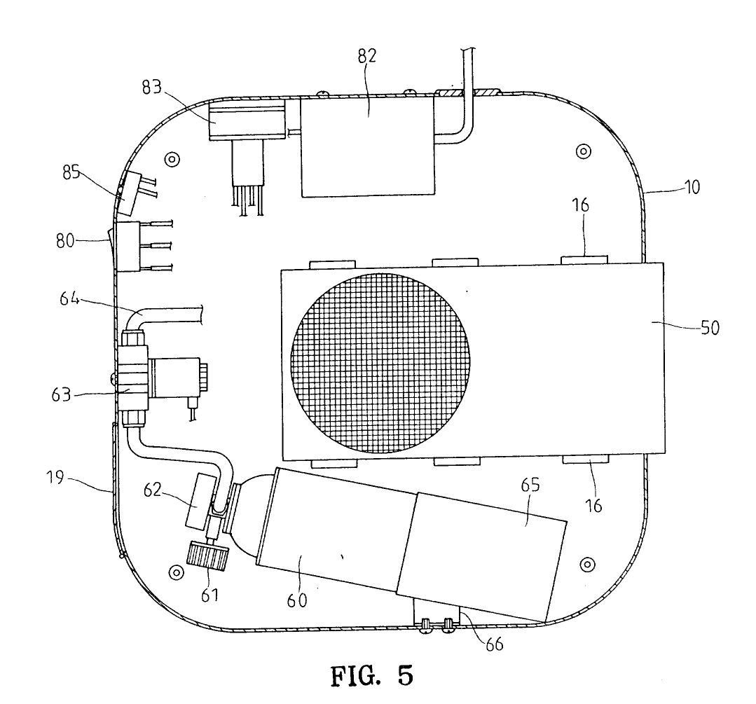

Referring to FIGS. 4 and 5, a carbon dioxide container 60 is mounted in the base 10. Preferably, the carbon dioxide container 60 contains pressurized carbon dioxide and is positioned in a holding member 65 that is fixed to the base 10 by a bracket 66. A pressure-regulating valve 61 and a pressure gauge 61 may be mounted to an outlet of the carbon dioxide container 6. Attached to a side of the base 10 is a lid 19 that can be opened to view the pressure gauge 61. A guide tube 64 (e.g., a hose) is connected to the outlet of the carbon dioxide container 60 and extended through a hole 101 in the base 10, a hole 28 in the lower frame 21, a hole 27 in the upper frame 20, and a hole 47 in the lamp shade 44, and then connected to the sleeve 72. Thus, carbon dioxide from the carbon dioxide container 60 is discharged to the environment via the guide tube 64, the hole 74 and the transverse passage 73 of the sleeve 72, and the carbon dioxide discharge hole 71 of the carbon dioxide discharging member 70. The mosquitoes would be lured toward the mosquito trap. An electromagnetic valve 63 may be mounted to the guide tube 64. An AC transformer 82 may be connected to a circuit board 84 electrically connected to all of the electric devices to control on/off of the electromagnetic valve 63 for discharging carbon dioxide at predetermined time.

In this embodiment, a lamp 42 is attached to an underside of the top cover 40 and faces the transparent lampshade 41. The lamp 42 is connected by a wire 43 to a power source to provide an additional lure to mosquitoes.

As illustrated in FIG. 4, the inlet chamber 200 and the outlet chamber 210 are located one on the other, with the fan motor 30, the blades 31, and the fan frame 32 positioned therebetween. The upper frame 20 is connected to the top cover 40 by the brackets 25 to define an annular air inlet.

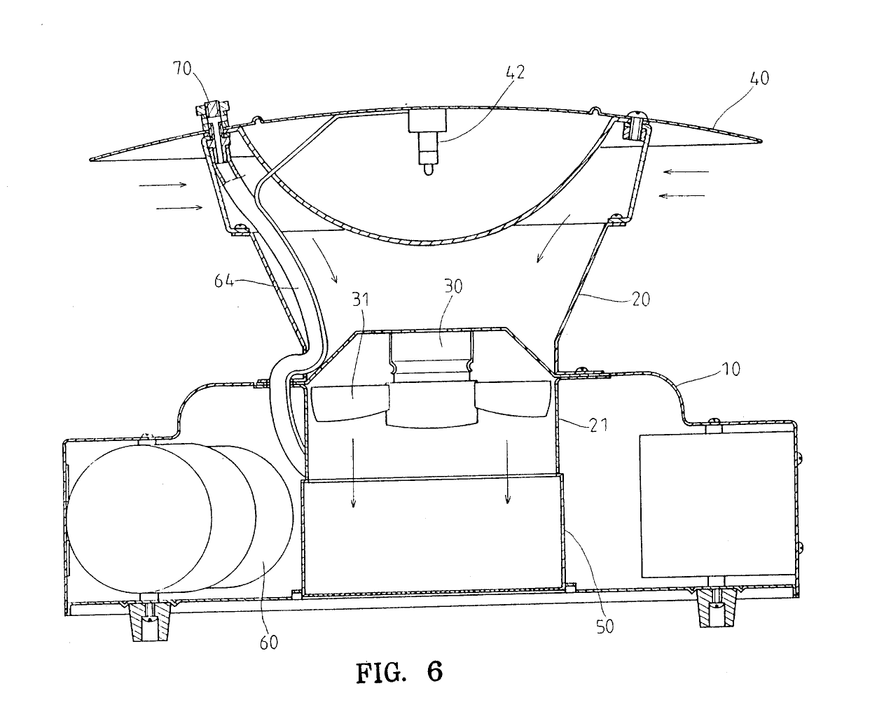

Referring to FIGS. 5 and 6, by means of controlling the electromagnetic valve 63, a small amount of carbon dioxide is intermittently discharged from the carbon dioxide container 60 to the environment through the carbon dioxide discharging member 70. The mosquitoes are lured to a position near the annular air inlet and then sucked into the base 10. The wind pressure device may create a strong wind up to 650 CFM that is not bearable to mosquitoes. Thus, the mosquitoes are trapped into and thus killed in the mosquito collection box 50.

Although the invention has been explained in relation to its preferred embodiment, it is to be understood that many other possible modifications and variations can be made without departing from the scope of the invention as hereinafter claimed.

What is claimed is:

1. A mosquito trap comprising:
a base;
a carbon dioxide container for discharging carbon dioxide to a position near the base;
a mosquito collection box mounted in the base; and
a fan motor for introducing air into the mosquito collection box.

2. The mosquito trap as claimed in claim 1, further including a lamp mounted outside the base.

3. The mosquito trap as claimed in claim 1, wherein the base includes an access through which the mosquito collection box is removably inserted into the base.

4. The mosquito trap as claimed in claim 1, wherein the fan motor creates a wind pressure sufficiently strong to kill mosquitoes trapped in the mosquito collection box.

5. A mosquito trap comprising:
a base having a central opening in a top side thereof;
a mosquito collection box removably mounted in the base;
a lower frame mounted in the base and located above the mosquito collection box, the lower frame defining an outlet chamber;
an upper frame mounted above the base and defining an inlet chamber in alignment with the central opening of the base and the outlet chamber;
a fan motor mounted in the central opening of the base, the fan motor driving ambient air into the mosquito collection box via the inlet chamber and the outlet chamber; and
a carbon dioxide container for discharging carbon dioxide to a position near the base.

6. The mosquito trap as claimed in claim 5, further including a top cover mounted on top of the upper frame, with an annular air inlet defined between the top cover and the upper frame.

7. The mosquito trap as claimed in claim 6, further including a lamp mounted to an underside of the top cover, with the lamp facing the inlet chamber.

8. The mosquito trap as claimed in claim 7, further including a transparent lampshade mounted below the top cover.

9. The mosquito trap as claimed in claim 6, further including a carbon dioxide discharging member mounted to the top cover, the carbon dioxide discharging member having a carbon dioxide discharge hole communicated with the carbon dioxide container.

10. The mosquito trap as claimed in claim 5, further including a power switch for controlling on/off of the fan motor.

11. The mosquito trap as claimed in claim 5, further including a light switch for turning on the fan motor at night and turning off the fan motor at day and for discharging carbon dioxide.

12. The mosquito trap as claimed in claim 5, further including a pressure gauge attached to an outlet of the carbon dioxide container.

13. The mosquito trap as claimed in claim 5, further including a pressure-regulating valve mounted to an outlet of the carbon dioxide container.

14. The mosquito trap as claimed in claim 5, further including an electromagnetic valve for controlling discharge of carbon dioxide from the carbon dioxide container.

15. The mosquito trap as claimed in claim 5, wherein the base includes a bottom cover attached thereto, the bottom cover having two rails, the mosquito collection box having an underside so configured to slide along the rails.

16. The mosquito trap as claimed in claim 15, wherein the base has an opening, the mosquito collection box having a through-hole defined in an end thereof and communicated with the opening of the base, with a mesh mounted to a bottom end of the through-hole.

17. The mosquito trap as claimed in claim 5, further including a plug and a transformer electrically connected to the fan motor.

18. The mosquito trap as claimed in claim 5, wherein the fan motor creates a wind pressure sufficiently strong to kill mosquitoes trapped in the mosquito collection box.
